(19) United States
(12) Patent Application Publication
(10) Pub. No.: US 2012/0034345 A1
(43) Pub. Date: Feb. 9, 2012

(54) LOW CALORIE DAIRY PRODUCTS

(76) Inventors: Vanessa Gauthier, Le Plessis Robinson (FR); Delphine Chatelin, Saint Remy Les Chevreuse (FR); Eric Taillan, Rixensart (BE); Remi Portier, Epinay Sur Orge (FR)

(21) Appl. No.: 13/264,812

(22) PCT Filed: Apr. 20, 2010
(86) PCT No.: PCT/EP10/55215

§ 371 Date: Oct. 17, 2011

(30) Foreign Application Priority Data
Apr. 20, 2009 (IB) PCT/IB2009/052798

(51) Int. Cl. A23C 9/137; A01J 11/00; A23C 9/12

(52) U.S. Cl. 426/61; 426/564; 426/565; 426/569; 99/460

(57) ABSTRACT

The present invention pertains to fermented dairy products with reduced caloric values, in particular to low-fat, milkshakes and smoothies having reduced amounts in sugar. The dairy products of the invention comprise gelatine. They have high foaming rates and are stable over time. Further, the present invention also relates to processes and kits-of-parts for obtaining said dairy products.

Currently marketed milkshake compositions are traditionally based on a neutral (i.e. non-fermented) milk product, combined with flavoured sugar syrups (e.g. vanilla or strawberry flavours). From a nutritional perspective, these products are unsatisfactory, since they have very high caloric values, extremely high contents in sugar(s) and fat(s). Such products can therefore not form part of a healthy and balanced diet regimen.

The present invention pertains to the field of healthy food products, having high nutritional value. More particularly, the present invention provides dairy products with reduced caloric values, which have reduced amounts in sugar and low fat contents, while exhibiting excellent organoleptic properties.

The present invention relates to a fermented dairy product, comprising (w/w):
0.5-0.9% of gelatine, and
0.0-0.5% of fat.

The notion of fermented dairy product is known to the skilled person in the field of the dairy industry. Fermented dairy products include fermented milks and yogurts. These products are generally obtained through fermentation of a dairy medium by lactic acid bacteria. Said dairy medium can be obtained or derived from animal milk, such as cow milk, goat milk, or sheep milk. Preferably, said dairy medium is derived from cow milk.

The skilled person is familiar with the fermentation techniques used in the dairy industry.

The dairy product of the invention is advantageously light and ‘aerated’: it contains a very important amount of gas bubbles. The level of aeration can be described either by the foaming rate, or by the specific gravity, as detailed below. This confers very interesting organoleptic properties to the dairy product of the invention: it is very ‘airy’, unctuous, and has no ‘jelly’ and no ‘watery’ feeling in mouth.

The dairy product of the invention comprises 0.5-0.9%, preferably 0.6-0.9%, preferably about 0.8% of gelatine (w/w).

Gelatine is known in the art of the dairy industry. Gelatine can be characterized by its gel strength, or bloom index.

According to the present invention, gelatine bloom index is defined using the following test:
The test uses a 12.7 mm diameter flat face, cylindrical probe with a sharp edge (AOAC and GME cylinder probe).
Gelatine is weighed into water to create a 6.67% solution in standard Bloom bottles with stoppers.
The mix is then stirred and left to hydrate for approximately 3 hours at room temperature. Once soaked, bottles are placed in a 65° C. bath for 20 minutes, stirring occasionally to assure that the gelatine is completely dissolved.
After allowing the Bloom jars to cool for 15 minutes at room temperature, they are then conditioned for 16 hours in 10° C. water bath.
The Bloom jar is centred with the probe just above the sample surface.
The test begins when the designated trigger force is reached. The probe then penetrates the gelatine to a target depth of 4 mm at a speed of 0.5 mm/s, and then retracts.

The peak force is accepted as the gel strength in Grams Bloom.

In preferred embodiments, said gelatine has a bloom index of 110-200, 115-160, more preferably 120-130, and even more preferably about 125.

With a bloom index of 110-200, according to the invention, the dairy product advantageously has an optimal texture and stability. Notably, the product if not ‘jelly-like’ and features high level of foaming rates. Further, the manufacturing process is also amply facilitated with a bloom index of 110-200 (see below).

The gelatine can be of various origins, including porcine, bovine or fish. Preferably, the gelatine is porcine gelatine.

The dairy product of the invention preferably comprises 0.0-0.5%, preferably 0.0-0.2%, preferably 0.0-0.1%, preferably 0.0-0.09%, preferably 0.0-0.08% of fat. This is obviously very advantageous from a nutritional standpoint.

Further, the dairy product of the invention has:
a temperature of −2° C. to 0.5° C., and
a caloric value of 55 kCal or below per 100 mL of dairy product.

The dairy product of the invention preferably has a caloric value of 53 kCal or below per 100 mL of dairy product; preferably of 52 kCal or below per 100 mL of dairy product; preferably of 50 kCal or below per 100 mL of dairy product.

Thus, in one aspect, the present invention provides a fermented dairy product, comprising (w/w):
0.5-0.9% of gelatine, and
0.0-0.5% of fat, preferably 0.0-0.2% of fat,

wherein said dairy product:
has a foaming rate of at least 50%, and/or comprises 0.0-0.5% of emulsifier(s),
has a temperature of −2° C. to 0.5° C., and
has a caloric value of 55 kCal or below per 100 mL of dairy product.

In one embodiment, the present invention provides a fermented dairy product comprising (w/w):
0.5-0.9% of gelatine, and
0.0-0.5% of fat, preferably 0.0-0.2% of fat,

wherein said fermented dairy product:
has a foaming rate of at least 50%,
has a temperature of −2° C. to 0.5° C., and
has a caloric value of 55 kCal or below per 100 mL of fermented dairy product.

In another embodiment, the present invention provides a fermented dairy product, comprising (w/w):
0.5-0.9% of gelatine,
0.0-0.5% of fat, preferably 0.0-0.2% of fat, and
0.0-0.5% of emulsifier(s),

wherein said fermented dairy product:
has a temperature of −2° C. to 0.5° C., and
has a caloric value of 55 kCal or below per 100 mL of fermented dairy product.

In a further embodiment, the present invention provides a fermented dairy product, comprising (w/w):
0.5-0.9% of gelatine,
0.0-0.5% of fat, preferably 0.0-0.2% of fat, and
0.0-0.5% of emulsifier(s),

wherein said fermented dairy product:
has a foaming rate of at least 50%,
has a temperature of −2° C. to 0.5° C., and
has a caloric value of 55 kCal or below per 100 mL of fermented dairy product.

The dairy product of the invention advantageously has a foaming rate of at least 60%, preferably at least 70%, preferably at least 80%, preferably at least 90%. The foaming rate indicates the level of aeration and the amount of gas contained in the dairy product. With such high levels of foaming rates, the dairy product of the invention is very ‘airy’ and light, thus featuring very pleasant organoleptic properties for the consumer.

Said foaming rate is defined using the test as follows:
First, the volume of the dairy product is measured (Volume 1)
The dairy product is then brought to room temperature, and treated to remove all gas bubbles therefrom (e.g. with ultra-sounds).
The volume of the resulting degassed dairy product is measured (Volume 2).
The foaming rate corresponds to (Volume 1−Volume 2)/(Volume 2).

Typically, the treatment for removing all gas bubbles is operated with ultra-sounds during 5 to 10 minutes. The removal of all gas bubbles is determined visually. The absence of gas bubbles is first determined by sight and then confirmed by microscope.

In another aspect, the present invention also provides a fermented dairy product, comprising (w/w):
0.5-0.9% of gelatine, and
0.0-0.5%; preferably 0.0-0.2% of fat,

wherein said dairy product:
has a specific gravity of at most 0.69
has a temperature of −2° C. to 0.5° C., and
has a caloric value of 55 kCal or below per 100 mL of dairy product.

The specific gravity of a substance refers to the ratio of the mass of a given volume of a substance to the mass of an equal volume of water (i.e. the ratio of their respective densities).

According to the invention, the dairy product has advantageously a specific gravity of at most 0.69; preferably of at most 0.65; preferably of at most 0.61; preferably of at most 0.58; preferably of at most 0.55). Again, with such values of specific gravity, the dairy product of the invention is very ‘airy’ and light, thus featuring very pleasant organoleptic properties for the consumer.

In one embodiment, the dairy product, according to the invention, comprises probiotic bacteria. Said probiotics bacteria are thus preferably alive.

The dairy product of the invention may comprise at least 10⁶ CFU of (live) probiotic bacteria per gram of dairy product, preferably at least 10⁷ CFU of (live) probiotic bacteria per gram of dairy product. The dairy product of the invention thus advantageously combines the healthy low-calorie, the low sugar and low fat contents, with the additional benefits of probiotics.

Said probiotic bacteria may be selected from a genus selected from the group consisting of Lactobacillus, Leuconostoc, Streptococcus, Lactococcus, Bifidobacterium, Enterococcus, and Pediococcus. More particularly, said probiotic bacteria may be selected from a species selected from the group consisting of Lactobacillus acidophilus, Lactobacillus plantarum, Lactobacillus casei subsp. casei, Lactobacillus casei subsp. rhamnosus, Lactobacillus lactis, Lactobacillus helveticus, Lactobacillus casei, Lactobacillus paracasei, Lactobacillus cremoris, Lactobacillus rhamnosus, Lactobacillus delbrueckii subsp. bulgaricus, Lactobacillus delbrueckii subsp. lactis, Lactobacillus delbrueckii subsp. delbrueckii, Lactobacillus delbrueckii subsp. bulgaricus, Lactobacillus reuteri, Lactobacillus amylovorus, Lactobacillus johnsonii, Lactobacillus fermentum, Lactobacillus brevis, Streptococcus thermophilus, Lactococcus lactis subsp. lactis, Lactococcus lactis subsp. cremoris, Bifidobacterium longum, Bifidobacterium breve, Bifidobacterium bifidum, Bifidobacterium infantis, Bifidobacterium lactis, Bifidobacterium animalis, Bifidobacterium animalis subsp. lactis, Bifidobacterium infantis, and Bifidobacterium adolescentis.

In preferred embodiments, the dairy product according to the invention comprises probiotic bacteria from a species selected from the group consisting of Bifidobacterium animalis, Bifidobacterium animalis subsp. lactis, Streptococcus thermophilus, Lactobacillus delbrueckii subsp. bulgaricus, Lactococcus lactis, and Lactococcus cremoris.

The dairy product of the invention is preferably stable, i.e. it retains its properties with respect to its level of aeration (foaming rate, respectively specific gravity) for at least 15 minutes, preferably for at least 20 minutes, more preferably for at least 30 minutes (after its manufacture). Further, the dairy product remains homogeneous for at least 10 minutes, preferably for at least 15 minutes, preferably for at least 20 minutes, more preferably for at least 30 minutes (after its manufacture), namely the product is macroscopically homogeneous, and there is very little, if any, formation of a second macroscopic phase. For example, there is less than 1%, preferably less than 5% (v/v) of phase separation.

The dairy product of the invention can be a beverage, preferably a frozen fermented milk, a frozen yogurt, a drinkable fermented milk, a drinkable fermented yogurt, a milkshake or a smoothie. Said beverage can be for eating with a spoon or a straw.

In one aspect, the dairy product of the invention comprises 0.0-0.5% of emulsifier(s). It comprises preferably 0.0-0.3%, more preferably 0.0-0.2% of emulsifier(s).

In preferred embodiments, the dairy product of the invention is free of any one of the emulsifiers selected from the group consisting of: mono- and di-glycerides, acetic acid esters of mono- and di-glycerides, lactic acid esters of mono- and di-glycerides, citric acid esters of mono- and di-glycerides, tartaric acid esters of mono- and di-glycerides, phospholipids, polyglycerols, propylene glycol esters, lactilate stearyle, sucroesters, and lactilate stearoyls.

In particular, the dairy product of the invention can be free of any one of the following: lactic acid esters, such as Lactem PQ22 (from palm oil); lactic acid esters of mono- and di-glycerides, such as Admul GLP 1147C (lactic acid esters of mono- and di-glycerides+calcium silicate); plant mono- and di-glycerides, such as Myverol 18-04K (monoglyceride); esters of plant mono- and di-glycerides, such as Admul datem: diacetyl-tartaric esters of plant mono- and di-glycerides.

Unexpectedly, it is observed that the presence of significant amounts of emulsifier(s) in the composition of the product negatively impacts the maximum foaming rates obtainable. Thus, contrary to the common teaching of the art, the use of emulsifiers in the dairy product of the invention does not contribute to higher foaming rates.

In another aspect, the dairy product of the invention may comprise at least one ingredient selected from the group consisting of sweeteners, sugars, flavours, fruit purees, fruit juices, thickening agents, stabilizing agents, colouring agents, acidity regulators, and preservatives. Such ingredients are well known to the skilled person who is familiar with the dairy and food industry ingredients.

The dairy product of the invention preferably has a pH of 4-4.5.

In another aspect, the present invention relates to a process for preparing a fermented dairy product.

In one embodiment, the process of the invention comprises the steps of:
preparing a mixture of a fermented dairy composition and a flavouring composition,
   wherein said fermented dairy composition comprises (w/w):
      0.5-0.9% preferably 0.6-0.9%; preferably about 0.8% of gelatine,
      0.0-0.5%; preferably 0.0-0.2% of fat,
   wherein said flavouring composition comprises at least one sweetener and/or one sugar and/or at least one flavour; and
cooling and blending said mixture to obtain a fermented dairy product having a foaming rate of at least 50% (preferably at least 60%, preferably at least 70%, preferably at least 80%, preferably at least 90%).

In another embodiment, the process of the invention comprises the steps of:
preparing a mixture of a fermented dairy composition and a flavouring composition,
   wherein said fermented dairy composition comprises (w/w):
      0.5-0.9% preferably 0.6-0.9%; preferably about 0.8% of gelatine,
      0.0-0.5%; preferably 0.0-0.2% of fat,
      0.0-0.5%; preferably 0.0-0.2% of emulsifier(s);
   wherein said flavouring composition comprises at least one sweetener and/or one sugar and/or at least one flavour; and
cooling and blending said mixture to obtain a foamed fermented dairy product.

In a further embodiment, the process of the invention comprises the steps of:
preparing a mixture of a fermented dairy composition and a flavouring composition,
   wherein said fermented dairy composition comprises (w/w):
      0.5-0.9% preferably 0.6-0.9%; preferably about 0.8% of gelatine,
      0.0-0.5%; preferably 0.0-0.2% of fat,
      0.0-0.5%; preferably 0.0-0.2% of emulsifier(s); and
   wherein said flavouring composition comprises at least one sweetener and/or one sugar and/or at least one flavour; and
cooling and blending the mixture to obtain a dairy product having a foaming rate of at least 50% (preferably at least 60%, preferably at least 70%, preferably at least 80%, preferably at least 90%).

The skilled person is very familiar with the fermentation techniques as used in the dairy industry, and with standard blending and cooling techniques. The skilled person knows how to provide a dairy composition, and how to ferment it, so as to provide a fermented dairy composition.

The gelatine is as described above. In a preferred embodiment, the gelatine is provided in the form of a powder having a US mesh of 8-60, more preferably 18-50 and even more preferably 20-45. The selection of such particle size distribution for the gelatine powder facilitates handling, blending, and other manufacturing steps at the industrial scale. It also contributes to better storage performances, including stability.

The foaming rate is as described above for the dairy product of the invention. In the context of the process of the invention, said foaming rate may alternatively also be defined as follows:
Before blending and cooling, a given volume V of the mixture [(fermented dairy composition)+(flavouring composition)] is weighed (W1).
After blending and cooling, the weight (W2) of the same given volume V of the resulting dairy product is determined.
The foaming rate (%) is [(W1/W2)−1]*100.
The foaming rate thus corresponds to the relative volume variation after blending and cooling.

In one aspect, in the process of the invention, said fermented dairy composition comprises 0.0-0.5% (w/w), preferably 0.0-0.2% of emulsifier(s). See the above comments as to the emulsifiers.

Preferably, the fermented dairy composition has a viscosity of 240-420 mPa·s, as measured after 10 seconds with a proRheo Rheomat 180 viscometer; at a shear rate of 64 s⁻¹ and at 10° C. Such features facilitate handling (pumpability) at the industrial scale. Preferably, this viscosity is of 280-380, more preferably of 300-350 mPa·s in the indicated measuring conditions.

Said sweetener is preferably selected from aspartame, acesulfame-K, sucralose, stevia, and mixtures thereof.

Said sugar is preferably sucrose, glucose (e.g. glucose syrup, isoglucose syrup), or a mixture of sucrose and glucose.

The flavour can be selected from fruit flavours, vanilla, etc. Fruit flavours include strawberry, wild strawberry, red berries, exotic fruits, banana, strawberry/banana.

Preferably, the flavouring composition has a viscosity of 350-750 mPa·s, as measured after 10 seconds with a proRheo Rheomat 180 viscometer; at a shear rate of 64 s⁻¹ and at 10° C. Preferably, this viscosity is of 400-700, more preferably of 500-600 mP·s in the indicated measuring conditions.

Said flavouring composition may also typically comprise water.

In a preferred embodiment, cooling is performed with liquid nitrogen (i.e. nitrogen below its boiling point), and blending and cooling are performed simultaneously. Blending and cooling man advantageously be performed with a device as disclosed in WO 2008/097088 (application PCT/2008/NL50068 in the name of BOEKHOORN et al.).

In one aspect, and more particularly with the mentioned viscosity ranges for the fermented dairy composition and for the flavouring composition, said blending is performed at a ratio of (fermented dairy composition) to (flavouring composition) of 100:0 to 85:15; preferably of 95:5 to 85:15 (w/w). More preferably, this ratio is of 90:10.

The present invention also relates to a kit-of-parts. This kit-of-parts is suitable form preparing the dairy product of the invention and/or for conducting the process of the invention.

In one aspect, the kit-of-parts of the invention comprises a fermented dairy composition (A) a flavouring composition (B). The kit-of-parts of the invention comprises:
a fermented dairy composition (A):
   comprising (w/w):
      0.5-0.9% of gelatine, and
      0.0-0.5%; preferably 0.0-0.2% of fat,
   having a viscosity of 240-420 mPa·s, as measured after 10 seconds with a proRheo Rheomat 180 viscometer; at a shear rate of 64 s⁻¹ and at 10° C.;
a flavouring composition (B):
   comprising at least one sweetener and/or at least one sugar and/or at least one flavour; and
   having a viscosity of 350-750 mPa·s, as measured after 10 seconds with a proRheo Rheomat 180 viscometer; at a shear rate of 64 s⁻¹ and at 10° C.

Both compositions (A) and (B) are described above as the fermented dairy composition and the flavouring composition.

In one embodiment, in the kit-of parts of the invention, the fermented dairy composition (A) comprises 0.0-0.5%, preferably 0.0-0.2% of emulsifier(s). See the above comments as to the emulsifiers.

In a preferred embodiment, said fermented dairy composition (A) has the following composition (w/w):
0.5-0.9%, preferably 0.6-0.9%, preferably about 0.8% of gelatine,
0.01-0.30%, preferably 0.05-0.15% of at least one feiment,
0.0-10.0%, preferably 4.0-6.0% of at least one added sugar,
q.s. skimmed milk.

The gelatine is described above. The ferment can be selected from the above mentioned lactic acid bacteria. Preferably said ferment comprises probiotic bacteria from a species selected from the group consisting of Bifidobacterium animalis, Bifidobacterium animalis subsp. lactis, Streptococcus thermophilus, Lactobacillus delbrueckii subsp. bulgaricus, Lactococcus lactis, and Lactococcus cremoris.

Said sweetener is preferably selected from aspartame, acesulfame-K, sucralose, stevia, and mixtures thereof.

Said sugar may be sucrose and/or glucose.

In one aspect, in the kit-of-parts of the invention said flavouring composition (B) further comprises at least one additive selected from the group consisting of sweeteners, fruit purees, fruit juices, thickening agents, stabilizing agents, colouring agents, acidity regulators, and preservatives. Such additives are well known to the skilled person in the food industry. Preferably, said flavouring composition is free of fat soluble ingredients. For example, said flavouring composition is preferentially free of oil-based colouring agents, such as paprika extract and beta carotene. Said flavouring composition (B) may also typically comprise water.

Advantageously, said flavouring composition (13) can stably be stored in a cold room. Preferably, it remains homogeneous 35 to 56 days after its manufacture.

In another aspect, the present invention relates to a vending machine. Said vending machine is suitable for the preparation and distribution of dairy products, and comprises:
a kit-of-parts according to the invention, and
means for blending and means for cooling.

In a preferred embodiment, the means for blending and means for cooling are similar to those in a device as disclosed in WO 2008/097088 (application PCT/20081NL50068 in the name of BOEKHOORN et al.). Said vending machine can be set in a public place, such a train station, an airport, a mall, a school or a hotel lobby.

In yet another aspect, the present invention relates to the use of gelatine with a bloom index of 110-200, in the manufacture of fermented dairy product having a foaming rate of at least 50%. In one embodiment, said gelatine has a bloom index of 110-200, preferably 115-160, more preferably 120-130, and even more preferably about 125. With a bloom index of 110-200, according to the invention, the dairy product advantageously has an optimal texture and stability.

Preferably, said gelatine is in the form of a powder. In preferred embodiments, the gelatine powder has a US mesh of 8-60, more preferably 18-50 and even more preferably 20-45. In the use of the invention, the dairy product is preferably a beverage, preferably a frozen fermented milk, a frozen yogurt, a drinkable fermented milk, a drinkable fermented yogurt, a milkshake or a smoothie.

### FIGURES

FIG. 1 represents the measure of the viscosity of the flavouring composition A comprising different mix of texturing agents. The ordinate left corresponds to the viscosity (in mPas). The ordinate right corresponds to the temperature (in ° C.). The line with squares (▪) corresponds to the variation of the temperature.

The abscissa expresses the different flavouring compositions A tested:
the number 1 corresponds to a favouring composition A with 2.4% of starch. Test repeated 3 times at 3 different temperatures.
the number 2 corresponds to a favouring composition A with 1.2% of starch and 0.25% of xanthan gum. Test repeated 2 times at 2 different temperatures.
the number 3 corresponds to a favouring composition A with 0.8% of starch and 0.25% of xanthan gum. Test repeated 2 times at 2 different temperatures.
the number 4 corresponds to a favouring composition A with 1.4% of starch and 0.25% of xanthan gum. Test repeated 3 times at 3 different temperatures.

FIG. 2 represents the measure of the viscosity of the flavouring composition B comprising different mix of texturing agents. The ordinate right corresponds to the viscosity (in mPas). The ordinate left corresponds to the temperature (in ° C.). The line with squares (▪) corresponds to the variation of the temperature.

The abscissa expresses the different flavouring compositions B tested:
the number 1 corresponds to a favouring composition B with 1.8% of starch. Test repeated 2 times at 2 different temperatures.
the number 2 corresponds to a favouring composition B with 1.2% of starch and 0.25% of xanthan gum. Test repeated 3 times at 3 different temperatures.
the number 3 corresponds to a favouring composition B with 0.8% of starch and 0.25% of xanthan gum. Test repeated 3 times at 3 different temperatures.
the number 4 corresponds to a favouring composition B with 1.1% of starch and 0.25% of xanthan gum. Test repeated 3 times at 3 different temperatures.

FIG. 3 represents the measure of the viscosity of the flavouring composition C comprising different mix of texturing agents. The ordinate right corresponds to the viscosity (in mPas). The ordinate left corresponds to the temperature (in ° C.). The line with squares (▪) corresponds to the variation of the temperature.

The abscissa expresses the different the different flavouring compositions C tested:
the number 1 corresponds to a favouring composition C with 1.8% of starch and 0.20% of xanthan gum. Test repeated 2 times at 2 different temperatures.
the number 2 corresponds to a favouring composition C with 1.8% of starch and 0.20% of xanthan gum. Test repeated 2 times at 2 different temperatures.
the number 3 corresponds to a favouring composition C with 1.2% of starch and 0.25% of xanthan gum. Test repeated 5 times at 5 difkrent temperatures.
the number 4 corresponds to a favouring composition C with 0.8% of starch and 0.25% of xanthan gum. Test repeated 2 times at 2 different temperatures.
the number 5 corresponds to a favouring composition C with 1.2% of starch and 0.25% of xanthan gum. Test repeated 4 times at 4 different temperatures.
the number 6 corresponds to a favouring composition C with 1.2% of starch and 0.25% of xanthan gum. Test repeated 2 times at 2 different temperatures and test done in batch of 800 kg (higher production volume).

### EXAMPLES

### Example 1

Compositions, Products and Processes

Various formulas are tested for dairy medium (see Table).

For each dairy medium, the process for preparing the dairy medium and fermenting same is as follows:
blending of the ingredients, except for the ferment;
heat treatment (including pasteurisation);
high pressure treatment (homogenization, for example at 200 bars);
inoculation of the dairy medium with the ferment;
fermentation of the resulting dairy medium to obtain a fermented dairy composition;
smoothing of the resulting fermented dairy composition (with a dynamic smoother, for example as described in WO 2007/095969);
storage in a cold room.

After one day storage, all fermented dairy compositions then have a viscosity of 240-420 mPa·s, as measured after 10 seconds with a proRheo Rheomat 180 viscometer; at a shear rate of 64 s⁻¹ and at 10° C. Such feature facilitates handling (pumpability) at the industrial scale. Each fermented dairy composition is then processed with a device as disclosed in WO 2008/097088 (blending and cooling with liquid nitrogen injection).

The results in terms of foaming rates are indicated in the tables.

All products have a caloric value of 55 kCal or below per 100 mL of dairy product.

| | Formulas | | | | | | | | |
|---|---|---|---|---|---|---|---|---|---|
| Ingredients | A | B | C | H | K | Q | R | S | T |
| Standard | 94.3 | 92.6 | 92.8 | 94.0 | 93.8 | 94.4 | 94.7 | 94.4 | 94.4 |
| Skim Milk, (fat 0.5 g/L 2005) | | | | | | | | | |
| Standard FR Cream | 4.3 | 3.6 | 3.1 | | | | | | |
| 400 g/kg 2005 | | | | | | | | | |
| Standard FR | 0.3 | 0.8 | 0.8 | | | | | | |
| Skim Milk Powder 2005 | | | | | | | | | |
| Emulsifier Lactem PQ22 | 0.3 | 0.5 | 0.7 | 0.9 | 0.9 | | | | |
| Danisco-Grinsted Taarnvej | | | | | | | | | |
| Gelatin 230 Bloom, | | 0.15 | | | | | | | |
| 45 Mesh Weishardt Graul | | | | | | | | | |
| Gelatin 225 Bloom, PST.60 | 0.9 | | | | | | | | |
| AT800 Rousselot St Michel | | | | | | | | | |
| Gelatin 160 Bloom, 20 | | | | 0.3 | | | | | |
| Mesh, Bovine Weishardt Graul | | | | | | | | | |
| Gelatin 130 Bloom, 50 Mesh, | | | 0.3 | | 0.5 | 0.8 | 0.5 | | |
| Pig Skin Weishardt Graul | | | | | | | | | |
| Gelatin 130 Bloom, 20 Mesh, | | | | | | | | | 0.8 |
| Gelita Minden | | | | | | | | | |
| Gelatin 125 Bloom, PST.30 | | | | | | | | 0.8 | |
| Rousselot St Michel | | | | | | | | | |
| Standard FR Sugar | | | | 4.8 | 4.8 | 4.8 | 4.8 | 4.8 | 4.8 |
| C N°2 Standard Supplier | | | | | | | | | |
| WPC Hiprotal 45 | | 1.2 | 1.2 | | | | | | |
| Borculo Domo-Beilen | | | | | | | | | |
| Sodium Caseinate | | 1.2 | 1.2 | | | | | | |
| Armor Protein-St Brice | | | | | | | | | |
| Total Components | 100 | 100 | 100 | 100 | 100 | 100 | 100 | 100 | 100 |
| Ferments | 0.15 | 0.15 | 0.15 | 0.15 | 0.15 | 0.15 | 0.15 | 0.15 | 0.15 |
| Results | − | − | − | − | − | + + | + + | + | + |

Legend:
+ + The dairy product has a foaming rate of more than 70%. This feature is stable, obtained for at least 15 minutes
+ The dairy product has a foaming rate of more than 50%. This feature is stable, obtained for at least 15 minutes
− The dairy product has a foaming rate of less than 50%.

X bloom bloom index of X

V mesh US mesh of Y

### Example 2

### Dairy Product According to the Invention

| INGREDIENTS | % (w/w) |
|---|---|
| Skimmed milk (0.5 g/L fat) | 94.25 |
| Crystal sugar | 4.80 |
| GELATIN 125 bloom PS 30 Mesh Rousselot | 0.80 |
| Ferment | 0.15 |
| TOTAL | 100.00 |

The above dairy composition is prepared, and then fermented. It has a viscosity of maximum 420 mPa·s, as measured after 10 seconds with a proRheo Rheomat 180 viscometer; at a shear rate of 64 s⁻¹ and at 10° C. It is then processed with a device as disclosed in WO 2008/097088 (blending and cooling with liquid nitrogen injection).

The resulting dairy product has a foaming rate of above 70%, and is stable. The caloric value is of 55 kCal or below per 100 mL of dairy product. The texture is very smooth, and the appearance is very satisfactory. The dairy product can be eaten from a cup, or drunk with a straw.

### Example 3

Fermented Dairy Product Comprising Probiotic Bacteria

A dairy product of the invention is prepared as in Example 2, using Bifidobacterium animalis subsp. lactis as ferment. Just after fermentation is completed, and before the composition is processed with a device as disclosed in WO 2008/097088, the fermented dairy composition contains at least 3.4×10⁷ CFU per gram of fermented dairy composition. After processing with the machine, the stable dairy product has a foaming rate of above 70%, and contains at least 3.4×10⁷ CFU per gram of fermented dairy product (CFU count using the TOS method (IDF 220—ISO 29981)). This dairy product thus offers all the health benefits associated with the presence of probiotics.

Advantageously according to the invention, the process does not significantly impact the concentration and survival of probiotics. Thus, the dairy products of the invention retain all the interesting health properties found with the fermented, no ‘aerated’ and non liquid-nitrogen treated, corresponding dairy composition.

### Example 4

Dairy Products with Flavours

Dairy products are prepared with various flavours: strawberry, wild strawberry, exotic fruits, banana, strawberry/banana.

Flavouring compositions are prepared, containing:
water,
sugar (sucrose and/or glucose syrup),
at least one food additive selected from texturing agents (thickeners), acidity regulators, colouring agents, flavours.

Examples of compositions prepared as follow:

| | A: forest fruit | B: strawberry | C: exotic fruit |
|---|---|---|---|
| Brix (° B) | 43 | 41 | 41 |
| Fibers (%) | 1.685 | 0.815 | 0.823 |
| Sugar (%) | 40 | 39.6 | 39.8 |
| Fruits (%) | 50 | 50 | 50 |

Different concentrations of texturing agents (starch alone or a mix of starch and xanthan gum) have been tested with each compositions A, B and C.

The goal is to use a mix of texturing agents less sensitive to variations of process and temperature.

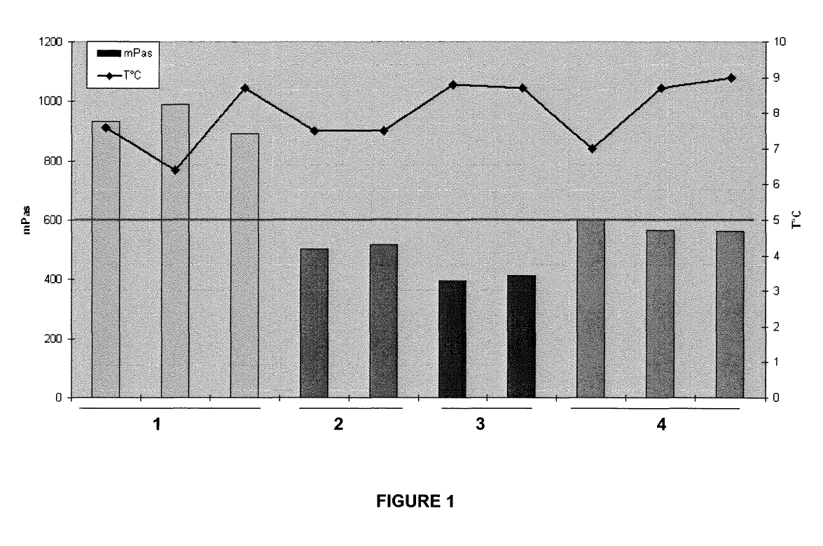

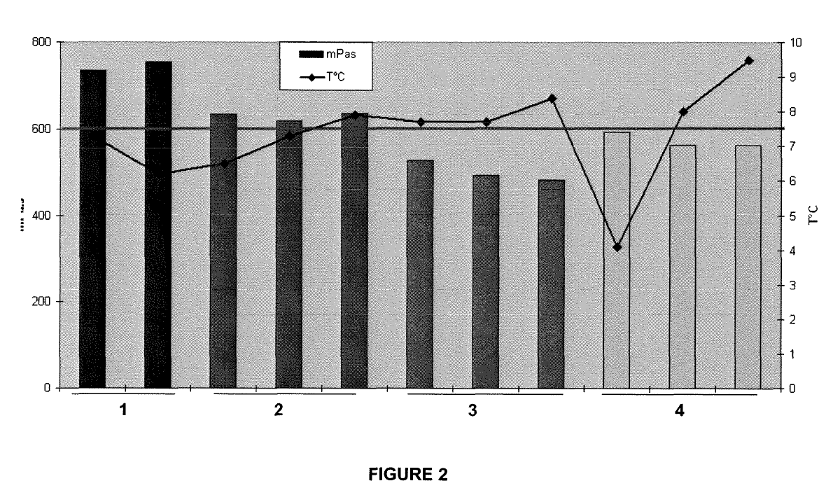

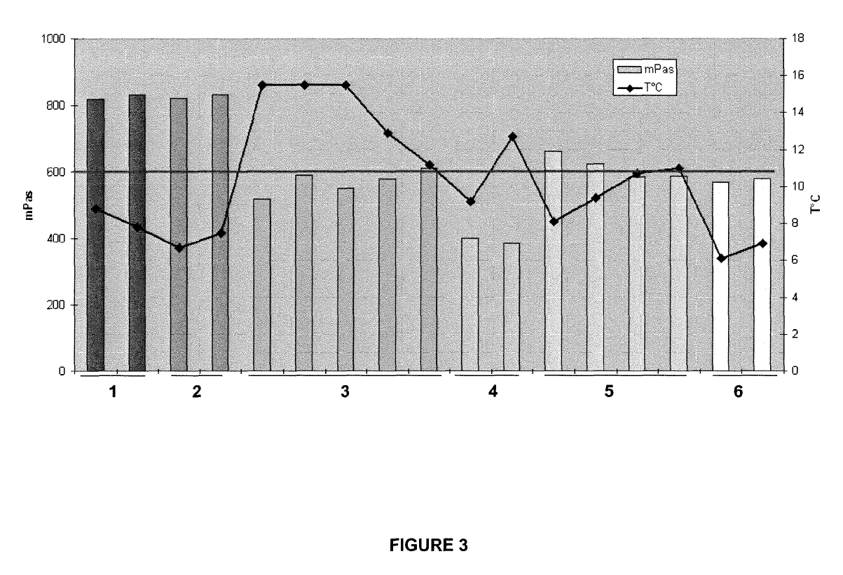

The optimized flavouring composition A comprised 1.4% of starch and 0.25% of xanthan gum (number 4, FIG. 1). The optimized flavouring composition B comprised 1.1% of starch and 0.25% of xanthan gum (number 4, FIG. 2). The optimized flavouring composition C comprised 1.2% of starch and 0.25% of xanthan gum (number 3, 5 and 6, FIG. 3). The viscosity is maintained at an optimized level (600 mPa·s) at different temperatures and at different production quantities.

In conclusion, the flavouring compositions (A, B and C) have a viscosity of 350-750 mPa·s, as measured after 10 seconds with a proRheo Rheomat 180 viscometer; at a shear rate of 64 s⁻¹ and at 10° C. The flavouring compositions are then blended and cooled with a fermented dairy composition as in Example 3 (at a ratio of fermented dairy composition to flavouring composition of 90:10 (w/w)), using a device as disclosed in WO 2008/097088. The resulting dairy products are stable, have a foaming rate of more than 70%, and excellent organoleptic properties, including a very smooth and unctuous texture. Additionally, they can form part of a healthy diet, due to their low-calorie values, and to the presence of probiotics.

1. Fermented dairy product, comprising (w/w):
0.5-0.9% of gelatine, and
0.0-0.5% of fat,
wherein said fermented dairy product:
has a foaming rate of at least 50%, and/or comprises 0.0-0.5% of emulsifier(s);
has a temperature of −2° C. to 0.5° C., and
has a caloric value of 55 kCal or below per 100 mL of fermented dairy product.

2. Fermented dairy product according to claim 1, comprising at least 10⁶ CFU of probiotic bacteria per gram of fermented dairy product.

3. Fermented dairy product according to claim 2, comprising probiotic bacteria from a species selected from the group consisting of Bifidobacterium animalis, Bifidobacterium animalis subsp. lactis, Streptococcus thermophilus, Lactobacillus delbrueckii subsp. bulgaricus, Lactococcus lactis, and Lactococcus cremoris.

4. Fermented dairy product according to claim 1, which is stable.

5. Fermented dairy product according to claim 1, which is a beverage, selected from frozen fermented milk, a frozen yogurt, a drinkable fermented milk, a drinkable fermented yogurt, a milkshake and a smoothie.

6. Fermented dairy product according to claim 1, wherein said gelatine has a bloom index of 110-200.

7. Fermented dairy product according to claim 1, further comprising at least one ingredient selected from the group consisting of sweeteners, sugars, flavours, fruit juices, fruit purees, thickening agents, stabilizing agents, colouring agents, acidity regulators, and preservatives.

8. Process for preparing a fermented dairy product, comprising the steps of:
preparing a mixture of a fermented dairy composition and a flavouring composition.
wherein said fermented dairy composition comprises (w/w):
0.5-0.9% of gelatine,
0.0-0.5% of fat,
0.0-0.5% of emulsifier(s); and
wherein said flavouring composition comprises at least one sweetener and/or at least one sugar and/or at least one flavour; and
cooling and blending the mixture to obtain a fermented dairy product having a foaming rate of at least 50%.

9. Process according to claim 8, wherein said gelatine is provided in the form of a powder having a US mesh of 8-60.

10. Process according to claim 8, wherein cooling is performed with liquid nitrogen, and said blending and cooling are performed simultaneously.

11. Process according to claim 8, wherein said blending is performed at a ratio of fermented dairy composition to flavouring composition of 100:0 to 85:15 (w/w).

12. Kit-of-parts suitable for the preparation of a fermented dairy product according to claim 1, wherein said kit-of-parts comprises:
a fermented dairy composition (A):
comprising (w/w):
0.5-0.9% of gelatine, and
0.0-0.5% of fat,
having a viscosity of 240-420 mPa·s, as measured after 10 seconds with a proRheo Rheomat 180 viscometer; at a shear rate of 64 s⁻¹ and at 10° C.;
a flavouring composition (B):
comprising at least one sweetener and/or at least one sugar and/or at least one flavour; and
having a viscosity of 350-750 mPa·s, as measured after 10 seconds with a proRheo Rheomat 180 viscometer; at a shear rate of 64 s⁻¹ and at 10° C.

13. Kit-of-parts according to claim 12, wherein said fermented dairy composition (A) comprises 0.0-0.5% of emulsifier(s).

14. Kit-of-parts according to claim 12, wherein said fermented dairy composition (A) has the following composition (w/w):
0.5-0.9% of gelatine,
0.01-0.30% of at least one ferment,
0.0-10.0% of at least one added sugar,
q.s. skimmed milk.

15. Kit-of-parts according to claim 12, wherein said flavouring composition (B) further comprises at least one additive selected from the group consisting of sweeteners, fruit juices, fruit purees, thickening agents, stabilizing agents, colouring agents, acidity regulators, and preservatives.

16. Vending machine for the preparation and distribution of fermented dairy products, comprising:
a kit-of-parts according to claim 12, and
means for blending and means for cooling.

17. Use of gelatine with a bloom index of 110-200, in the manufacture of a fermented dairy product having a foaming rate of at least 50%.

18. Use according to claim 17, wherein said gelatine is in the form of a powder having a US mesh of 8-60.

19. Use according to claim 17, wherein the fermented dairy product is a beverage, selected from a frozen fermented milk, a frozen yogurt, a drinkable fermented mile, a drinkable fermented yogurt, a milkshake or a smoothie.
